(19) United States
(12) Patent Application Publication
(10) Pub. No.: US 2022/0164874 A1
(43) Pub. Date: May 26, 2022

(54) Privacy Separated Credit Scoring System

(71) Applicant: Eureka Analytics Pte Ltd, Singapore (SG)

(72) Inventors: Jan Sindlar, Singapore (SG); Tim Xu, Singapore (SG); Ying Li, Singapore (SG)

(73) Assignee: Eureka Analytics Pte Ltd, Singapore (SG)

(21) Appl. No.: 17/437,079

(22) PCT Filed: Apr. 2, 2019
(86) PCT No.: PCT/SG2019/050191

§ 371 Date: Sep. 8, 2021

(51) Int. Cl. G06Q 40/02; G06F 21/62; H04W 12/02

(52) U.S. Cl. CPC G06Q 40/025; H04W 12/02; G06F 21/6245

(57) ABSTRACT

Banking and telecommunication network data may be combined to generate credit scores by separating aspects of credit score computation to protect the privacy of consumers and each institution that may collect data. A system of unsupervised, semi-supervised, or adaptive learning may be separated between a bank and a telecommunications network. Telecommunications networks may generate summarized statistics of their users, which may be combined into a formula for calculating an estimated credit score. The factors used for the formula may be transmitted to the bank, which may compare the calculated scores with actual financial behavior. The bank may generate updated factors, which may be returned to the telecommunications network to update the credit scoring formula.

### CROSS REFERENCE TO RELATED APPLICATIONS

This application claims credit of and priority to Patent Cooperation Treaty Application PCT/SG2019/050191 entitled “Privacy Separated Credit Scoring Mechanism” filed 2 Apr. 2019 by Eureka Analytics Pte. Ltd., the entire contents of which are hereby expressly incorporated by reference for all they disclose and teach.

### BACKGROUND

Credit scoring has been used to classify the credit risk of individual consumers. In many cases, credit scoring may be based on financial interactions that a consumer may have, such as taking out loans and making payments on the loans, making purchases, depositing money in savings accounts, and other activities.

However, many consumers may not have a lengthy financial history, which may make credit scoring inaccurate or impossible. Such consumers may be people in countries with many cash-based transactions or young consumers who may have little financial history. Such consumers may struggle to establish a financial history to build up a credit score.

Telecommunications networks may collect data that may reflect consumer behaviors, and those behaviors may correlate with credit scores. However, there are many privacy issues that may be raised with using such data. Data held by telecommunications companies are often regulated by law or convention. Similarly, banks and other financial institutions are similarly restricted from sharing information about their customers.

### SUMMARY

Banking and telecommunication network data may be combined to generate credit scores by separating aspects of credit score computation to protect the privacy of consumers and each institution that may collect data. A system of unsupervised, semi-supervised, or adaptive learning may be separated between a bank and a telecommunications network. Telecommunications networks may generate summarized statistics of their users, which may be combined into a formula for calculating an estimated credit score. The factors used for the formula may be transmitted to the bank, which may compare the calculated scores with actual financial behavior. The bank may generate updated factors, which may be returned to the telecommunications network to update the credit scoring formula.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a credit scoring mechanism that may use telecommunications network data.

FIG. 2 is a diagram illustration of an embodiment showing a network environment for generating credit scores using telecommunications network data.

FIG. 3 is a flowchart illustration of an embodiment showing a method for using mathematically descriptive statistics to predict credit scores.

FIG. 4 is a flowchart illustration of an embodiment showing a method for calculating predictive credit scores executed by a banking institution.

FIG. 5 is a flowchart illustration of an embodiment showing a method for using predictive credit scores calculated by a telecommunications network for advertising.

### DETAILED DESCRIPTION

Privacy Separated Credit Scoring Mechanism

Telecommunications networks generate large amounts of data from their subscribers, and that data may be processed into a set of statistics that may be useful for many different applications, including credit scoring. Telecommunications networks may have a limited amount of financial transaction information about their subscribers. For example, a telecommunications network may have purchase and payment history about their subscribers, which may give a glimpse into a subscriber's creditworthiness.

However, financial institutions may have a much more rich set of financial behavior data on their customers. Banks may have exposure to a customer's loan and payment history, their purchasing history through credit card transactions, and other financial data. Using such data, a bank may be able to access their customer's creditworthiness.

The two data sources may be used together without exposing the raw data from each source to the other.

A telecommunications network may create a formula for calculating a credit score, with the formula having weighting factors for each of several statistics generated from the telecommunications data. The statistics and weighting factors for individual consumers may be transmitted to a financial institution, which may compare the calculated credit scores with actual creditworthiness as determined by the financial institution. The financial institution may re-calculate the weighting factors and transmit the updated weighting factors to the telecommunications network.

Such a system may isolate the telecommunications data and the financial institution data from each other. The telecommunications network may not be exposed to the financial institution's detailed knowledge about a subscriber's financial behavior, and the financial institution may not be exposed to the telecommunications network's knowledge about the subscriber's online and physical behavior. By separating the two sets of data, both institutions may be insulated from either unlawful or unintentional disclosure, yet both institution's data may contribute to a highly accurate and meaningful credit scoring system.

Mathematical Summaries of Telecommunications Data for Data Analytics

Telecommunications networks may have access to subscriber usage behavior that may be used for various applications, such as targeted advertising, credit score analysis, classification, and other functions. These behavior characteristics may help identify subscribers that share common traits, which may be useful in different business contexts.

One of the benefits, and one of the complexities of telecommunications data is that extremely large amounts of data may exist. For example, each typical cellular phone may perform handshaking with a cell tower on a very high frequency, which may be on the order of every minute or less. Minute by minute observations of every subscriber for millions of subscribers result in data sets that may be extremely large and cumbersome, yet may be very detailed and rich with potential meaning.

Mathematical summaries of telecommunications data may include statistics that may capture subscriber behavior in manners that may be difficult to observe otherwise. Such statistics may be either impossible to observe in the physical world or may not correlate to observations in the non-telecommunications world, and therefore social engineering attacks or other privacy issues relating to such statistics may be lessened.

Privacy vulnerabilities including social engineering attacks may use so-called “open source intelligence,” which may be information about a person that may be publicly available or publicly observable. Publically available information may be, for example, property ownership records that may identify the owner of a home. Publicly observable data may be the observation of a subscriber as the subscriber waits at a public bus stop. Additionally, some observations about a person may not be publicly observable but may be observable by a third party, such as information regarding a retail transaction made by a subscriber at a local store.

Such non-telecommunications-related intelligence about individual subscribers may be difficult if not impossible to correlate with mathematical summaries of telecommunications data. Because correlation may be very difficult, the presence of such mathematical summaries may not pose a privacy vulnerabilities. Some analysts may consider such mathematical summaries “inherently” private because of the lack of correlation with directly observable characteristics.

The privacy characteristics of mathematical summaries may dramatically reduce the legal exposure of companies handling such summaries. Many jurisdictions have laws that restrict the transfer of personally identifiable information, and by handling only mathematical summaries of telecommunications data, useful data may be shared without compromising privacy laws or without identifying individual subscribers.

In many cases, summary statistics gathered from telecommunications data may not correlate with directly observable physical activities because of inherent inaccuracies in the telecommunications data. For example, consider a statistic of a radius of gyration, which may represent a subscriber's radius of movement over a period of time, such as a day, week, work week, weekend, month, or some other time period. Even when a subscriber's radius of gyration may be calculated with the highest level of precision of latitude and longitude available from the telecommunications network, such latitude and longitude numbers may be that of the cell towers to which a subscriber's device may communicate. Such cell towers may be miles or kilometers away from the actual location of the subscriber. Consequently, a physical observation of a subscriber's daily activities could be used to calculate a radius of gyration, but such a radius of gyration may not exactly match a radius of gyration calculated using telecommunications network data.

The net result may be that if a subscriber's mathematical summary of a radius of gyration were publically available, there may be no way to physically observe that the specific radius of gyration correlated to that specific subscriber. In such a situation, the radius of gyration may be an inherently private statistic for which no separate set of physical observations can correlate to the statistic generated from telecommunications data.

Such mathematical summaries may be considered to be second, third, or higher order representations of subscriber behavior. A first order observation of a subscriber behavior may be a subscriber's presence at a physical location and at a specific time. A second order statistic may be a journey along a street or bus line. A third order or higher order statistic may gather all journeys into a single representation, such as a radius of gyration. A higher order statistic may analyze the changes in radius of gyration over time, such as to determine that a subscriber may have taken journeys outside of the subscriber's normal movement patterns.

Such high order statistics may not compromise a subscriber's identity but may capture information that may be useful for many applications, such as for advertising, transportation or movement pattern analysis, credit scoring, or countless other uses for the data.

Many mathematical statistics may not correlate with conventional semantic descriptors of a subscriber. Semantic descriptors, for the purposes of this specification and claims, may be any descriptor that may be observed from non-telecommunications data. Examples of semantic descriptors may be gender, age, race, job description, income, and the like.

In some cases, some semantic descriptors may be estimated or implied from telecommunications data. For example, a subscriber's family size may be implied based on the SMS text and calling patterns of the subscriber, as well as analysis of the movement of those people with whom the subscriber frequently communicates. The communication patterns may identify people with whom the subscriber has an ongoing relationship, and the movement patterns may identify those people who may be in the same location as the subscriber at various times of day, such as in the evening when the subscriber's family may gather at home.

Mathematical descriptors that may be semantic-free may be those descriptors that do not correlate with characteristics that may be readily observable outside of the telecommunications network data. Such statistics may refer to a subscriber's interactions with the telecommunications network, their physical movement patterns as derived from telecommunications network observations, and other characteristics.

Some telecommunications network observations may be inherently non-observable from outside the telecommunications network. For example, a subscriber's usage of SMS text and voice calls may not be observable without access to the telecommunications network logging and observation infrastructure. In many jurisdictions, the contents of a subscriber's communications may be private and unavailable without a court order, but the metadata relating to such communications may or may not be accessible. Such metadata may indicate the phone number called by a subscriber, whether the call or text was inbound or outbound, the length of the call or text, and other observations.

Another example of inherently non-observable telecommunications data may relate to a subscriber's physical movements. Many movements of mobile devices may be observed by a telecommunications network with poor accuracy. For example, many location observations may be given as merely the location of a cell tower to which a subscriber may be connected, or a relatively coarse estimation of location by triangulating a location between two, three, or more cell towers. When a cell tower location may be given as a subscriber's location estimation, the cell tower may be several kilometers or miles away from the actual subscriber. Similarly, triangulated locations may be accurate to plus or minus several tens or hundreds of meters.

In some cases, a subscriber's device may generate Global Positioning System or other satellite-based location data. In many cases, such satellite location data may be much more accurate than location observations gathered from cellular towers. However, such satellite location data may typically consume battery energy from a subscriber device and may not be used at all times. In some cases, highly accurate data, such as satellite location data, may be obscured, desensitized, salted, or otherwise obfuscated prior to generating statistics such that the telecommunications observations may not directly correlate with physical observations.

Such inherent inaccuracy may be sufficient for the telecommunications network to manage network loads, yet may be so inaccurate that a physical observation of a subscriber at a specific location may not directly correlate with the telecommunications network's observation of that subscriber. In this manner, telecommunications network observations may be inherently unobservable in the physical world and therefore statistics generated from such observations may inherently shield a subscriber from being identified from the statistics.

Higher order statistics may have more inherently private characteristics since identifying a specific subscriber may be increasingly more difficult. For example, the number of text messages sent in an hour may be considered a first order statistic, which may be nearly impossible to observe without access to telecommunications network data. However, the mean number of text messages per hour made by the subscriber over a day may be much more difficult to observe. The mean, in this case, may be considered a second order statistic, as the mean can be considered to encapsulate multiple first order statistics. The covariance of a subscriber's text messages per hour over the course of a week may be a third order statistic, and would be increasingly difficult to observer without direct access to telecommunications network data. A higher order statistic may be an entropy analysis of a subscriber's text behavior over a period of time, for example.

Such higher order statistics may capture valuable and useful behavior characteristics of subscribers without giving away the identity of a specific subscriber, even if the statistics were publicly accessible.

Database records with first order or higher statistics may be very difficult or impossible to identify a specific subscriber from the statistics. Using the example of the statistics above, a database record with a subscriber's number of text messages per hour, the mean text messages sent per hour, the covariance of text messages per hour, and the entropy of text behavior would not enable an outside observer to identify which subscriber has those characteristics, unless the observer had direct access to the underlying telecommunications data.

Such may not be the case when semantic meaning may be interpreted from telecommunications data. Semantic meaning may include demographic information, such as gender, age, income level, family size, and other information. Such semantic identifiers may be readily observable in the real world and may compromise the privacy of a database of mathematically descriptive statistics.

In many cases, databases of mathematical statistics of telecommunications network data may include anonymized identifiers for subscribers. For example, a database of statistics may include a hashed or otherwise anonymized identifier for a subscriber's telephone number or other identifier, along with the statistics derived from the subscriber's observations. Some systems may maintain a database table that may correlate the subscriber's actual identifier, such as a telephone number, with the hashed or anonymized identifier. Such a table may be protected using the same techniques and standards as private subscriber data, but a database with hashed or anonymized identifiers along with semantic-free, mathematically descriptive statistics may be shared without jeopardizing subscriber privacy.

One factor that may affect the privacy of subscribers may be the scarcity of data. In an extreme example, a telecommunications network with a single subscriber may generate statistics that may inherently identify the only subscriber. However, with thousands or even millions of subscribers, a single set of observations may not allow a party without access to personally identifiable information to identify a subscriber.

Some systems may analyze queries to ensure that at least a predefined number of results may be returned from a query. When a query returns less than the predefined number of results, the query may be performed with obfuscated or otherwise less accurate data. For example, a query that may return location-based observations may be re-run with desensitized location data such that a larger number of results may fulfil the query. Some systems may return salted, fictitious, or modified results in addition to the true results such that an analyst may not be able to identify a valid result.

Throughout this specification, like reference numbers signify the same elements throughout the description of the figures.

In the specification and claims, references to “a processor” include multiple processors. In some cases, a process that may be performed by “a processor” may be actually performed by multiple processors on the same device or on different devices. For the purposes of this specification and claims, any reference to “a processor” shall include multiple processors, which may be on the same device or different devices, unless expressly specified otherwise.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

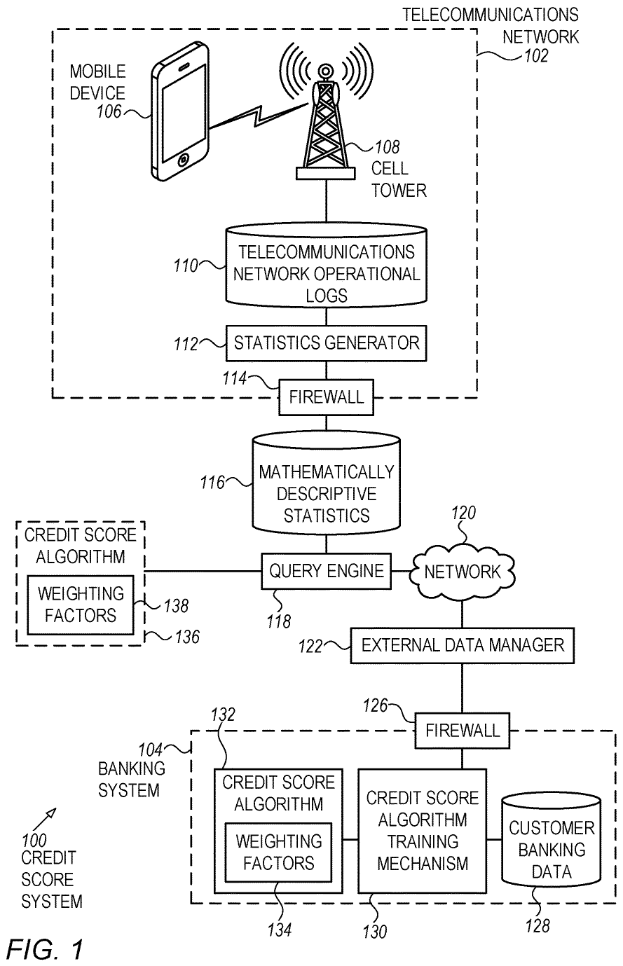

FIG. 1 is a diagram illustration of an embodiment 100 showing a system for calculating credit scores for individuals. The system may use observations from a telecommunications network to classify individuals, as well as credit related information from a bank or other financial system.

The arrangement of embodiment 100 may protect the sensitive information from both the telecommunications network 102 and the banking system 104. The telecommunications network 102 may have observations about their subscriber's behavior, and such information may be considered proprietary to the network. In many cases, such information may be protected or restricted by law. Similarly, banking or other financial information may also be proprietary and protected or restricted by law.

The arrangement of embodiment 100 may separate the two data sources, yet may combine the two for credit score calculations. In some cases, neither data source may be exposed to the other's sensitive information.

A mobile device 106 may communicate with various cell towers 108. In so doing, a telecommunications network 102 may generate many different logs 110. The logs may include, for example, periodic pings between the network and the mobile devices, call data records for voice and text communications, deep packet inspection of data communications, and other data.

A statistics generator 112 may generate a set of mathematically descriptive statistics 116, which may be made available outside a firewall 114. The raw data logs 110 may be considered sensitive or proprietary data to the telecommunications network 102. However, the mathematically descriptive statistics 116 may be anonymized or have inherently anonymous characteristics such that these statistics may be available to third parties without violating subscriber's privacy. The statistics 116 may be available through a query engine 118, which may respond to queries from third parties.

A network 120 may connect the telecommunications network 102 and a banking system 104. The banking system 104 may have an external data manager 122, which may communicate between the banking system 104 and outside data sources, such as the query engine 118.

Within the banking system firewall 126, a banking system 104 may have a customer banking database 128. Such a database may have customer's financial behavior, such as their loans, payments, account balances, purchases, as well as defaults, late payments, and other financial behavior. Such information may traditionally be used for calculating credit scores. A credit score may be used to evaluate whether or not a consumer may be an appropriate risk for a loan or some other financial transaction.

A credit score algorithm training mechanism 130 may use regression or some other mechanism to determine weights for each data element provided in the mathematically descriptive statistics 116. In some cases, there may be 50, 100, or more statistics that may be made available to express a subscriber's behavior. Each factor may be weighted so that a credit score may be calculated by multiplying the weight and the statistic, then summing the total.

In many cases, the data received from the mathematically descriptive statistics 116 may be “binned” or classified prior to being used in a calculation. An example may be found in Table 1:

TABLE 1
Example Binning of Statistics.

| | | Weight of | Co- |
|---|---|---|---|
| Feature | Bin | evidence | efficient |
| Comm_count_call | x <0.507 | −0.203 | −0.881 |
| Comm_count_call | 0.507 <= x < 3.922 | 0.238 | −0.881 |
| Comm_count_call | 3.922 <= x < 5.226 | 0.051 | −0.881 |
| Comm_count_call | 5.226 <= x < 6.804 | −0.254 | −0.881 |
| Comm_count_call | 6.804 <= x | −0.561 | −0.881 |
| Comm_count_call | x is missing | 0.065 | −0.881 |
| Home_circle_id_MEAN | x <102 | 0.187 | −0.954 |
| Home_circle_id_MEAN | 102 <= x < 105 | −0.322 | −0.954 |
| Home_circle_id_MEAN | 105 <= x < 113 | 0.014 | −0.954 |
| Home_circle_id_MEAN | 113 <= x < 115 | −0.326 | −0.954 |
| Home_circle_id_MEAN | 115 <= x | 0.126 | −0.954 |
| Home_circle_id_MEAN | x is missing | −0.032 | −0.954 |
| Sub_tenure_MAX | x <444.5 | −0.264 | −0.971 |
| Sub_tenure_MAX | 444.5 <= x < 816.5 | −0.113 | −0.971 |
| Sub_tenure_MAX | 816.5 <= x < 2362.5 | 0.078 | −0.971 |
| Sub_tenure_MAX | 2362.5 <= x < 2819.5 | 0.354 | −0.971 |
| Sub_tenure_MAX | x >2819.5 | 0.622 | −0.971 |
| Sub_tenure_MAX | x is missing | −0.023 | −0.971 |
| Connectivity_WIFI_mean | x <−84 | 0.051 | −0.877 |
| Connectivity_WIFI_mean | −84 <= x < −13 | −0.326 | −0.877 |
| Connectivity_WIFI_mean | −13 <= x < 0.07 | −0.07 | −0.877 |
| Connectivity_WIFI_mean | 0.07 <= x < 0.9 | −0.259 | −0.877 |
| Connectivity_WIFI_mean | 0.9 <= x | 0.366 | −0.877 |
| Connectivity_WIFI_mean | x is missing | −0.022 | −0.877 |

In Table 1, a “feature” may be a statistic that may be compiled from raw telecommunications data. The raw data may be assigned to a specific bin, where each bin is assigned the “weight of evidence” value. For example, when connectivity_wifi_mean has a value of 0.5, it would be assigned the fourth bin and given the value −0.259, which is the weight of evidence for this bin. The “coefficient” in the table may be the weight applied to that factor for determining a credit score. The credit score may be calculated by finding the raw statistic values, determining which bins each of the values applies, determining the weight of evidence for the bins, then multiplying the weight of evidence by the coefficient. The sum of all the value would be a credit score.

This example illustrates but a handful of factors, but in a typical system, a telecommunications network may 50, 100, or more statistics, each of which may contribute to the credit score.

The credit score algorithm training mechanism 130 may use the customer banking data 128 as a ground truth for determining the weights or coefficients as illustrated in Table 1. In many cases, such training may be linear regression, an iterative process, or some other mathematical method by which the weights may be determined.

The binning example of Table 1 is one method by which telecommunications statistics may be further simplified as part of calculating a credit score. In some cases, the binning process may occur on the telecommunications network side, where the banking system 104 may receive a vector of the “weight of evidence” values for each subscriber. The vector may be an ordered list corresponding to the statistics, which may then have the weights applied and summed to calculate a credit score.

In some systems, the banking system 104 may receive the statistics prior to binning, and the binning process may be performed by the banking system 104 as part of the credit score algorithm 132.

In systems where the credit score algorithm 132 may be performed by the banking system 104, the banking system 104 may request a vector of statistics from the telecommunications network 102 for a specific customer or set of customers. The banking system 104 typically would use this mechanism when a customer may apply for a loan or other financial service, and the customer would consent to having their credit score determined. With such permission, the banking system 104 may request the customer's data from the telecommunications network 102, receive the data, and calculate a credit score.

In some cases, the credit score algorithm 136 along with the weighting factors 138 may be performed by the telecommunications network 102. One use case may be for the telecommunications network 102 to calculate credit scores across its population of subscribers. A bank may then request access to those subscribers fitting a specific credit profile, and the bank may then advertise or market to those subscribers. For example, a bank may wish to reach customers in a local area with a credit score within a specific range, as the bank may have a product tailored to that set of customers.

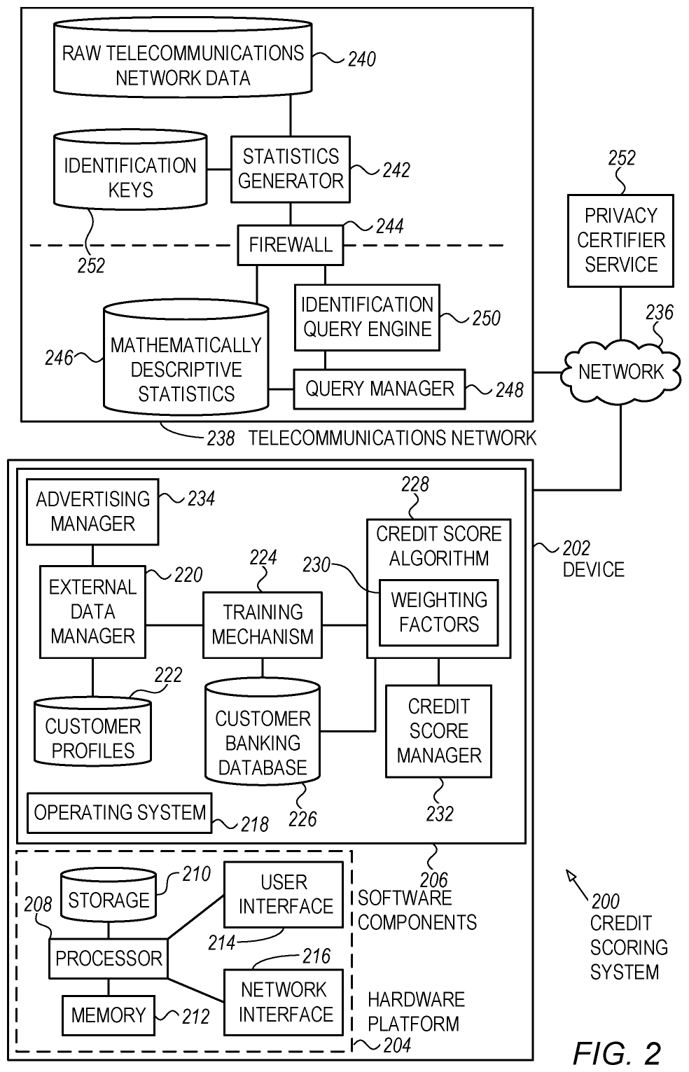

FIG. 2 is a diagram of an embodiment 200 showing components that may calculate credit scores using telecommunications network data. The system may be configured such that proprietary information of a bank and of a telecommunications network may be separated, yet combined to calculate credit scores.

The diagram of FIG. 2 illustrates functional components of a system. In some cases, the component may be a hardware component, a software component, or a combination of hardware and software. Some of the components may be application level software, while other components may be execution environment level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

Embodiment 200 illustrates a device 202 that may have a hardware platform 204 and various software components. The device 202 as illustrated represents a conventional computing device, although other embodiments may have different configurations, architectures, or components.

In many embodiments, the device 202 may be a server computer. In some embodiments, the device 202 may still also be a desktop computer, laptop computer, netbook computer, tablet or slate computer, wireless handset, cellular telephone, game console or any other type of computing device. In some embodiments, the device 202 may be implemented on a cluster of computing devices, which may be a group of physical or virtual machines.

The hardware platform 204 may include a processor 208, random access memory 210, and nonvolatile storage 212. The hardware platform 204 may also include a user interface 214 and network interface 216.

The random access memory 210 may be storage that contains data objects and executable code that can be quickly accessed by the processors 208. In many embodiments, the random access memory 210 may have a high-speed bus connecting the memory 210 to the processors 208.

The nonvolatile storage 212 may be storage that persists after the device 202 is shut down. The nonvolatile storage 212 may be any type of storage device, including hard disk, solid state memory devices, magnetic tape, optical storage, or other type of storage. The nonvolatile storage 212 may be read only or read/write capable. In some embodiments, the nonvolatile storage 212 may be cloud based, network storage, or other storage that may be accessed over a network connection.

The user interface 214 may be any type of hardware capable of displaying output and receiving input from a user. In many cases, the output display may be a graphical display monitor, although output devices may include lights and other visual output, audio output, kinetic actuator output, as well as other output devices. Conventional input devices may include keyboards and pointing devices such as a mouse, stylus, trackball, or other pointing device. Other input devices may include various sensors, including biometric input devices, audio and video input devices, and other sensors.

The network interface 216 may be any type of connection to another computer. In many embodiments, the network interface 216 may be a wired Ethernet connection. Other embodiments may include wired or wireless connections over various communication protocols.

The software components 206 may include an operating system 218 on which various software components and services may operate.

The device 202 may represent operations that may be performed by a bank or other financial institution. An external data manager 220 may interact with third party data sources to exchange information. The external data manager 220 may obtain a set of phone numbers from customer profiles 222, send those phone numbers to the telecommunications network 238, and receive back statistics corresponding to the phone numbers. The statistics may be in the form of a vector of binned or raw data.

The statistics may be used by a training mechanism 224 to use regression or other mathematical mechanism to determine a set of weights to apply to the statistics. The weights may be multiplied by the statistics values as part of a calculation of credit scores.

A customer banking database 226 may have historical banking or other financial information about their customers. From these data, a bank may classify the credit risk of their customers. The bank's determination of credit risk may be the ground truth from which weights 230 may be determined in a credit scoring algorithm 228.

A credit score manager 232 may be a component that may determine credit scores for new or existing customers. The credit score manager 232 may receive a telephone number or other identifier for a customer or prospective customer, then may retrieve a corresponding vector of telecommunications statistics. The statistics may be used by the credit scoring algorithm 228 to calculate a credit score, which may be used to approve or deny a financial product for the customer.

An advertising manager 234 may execute advertising campaigns using credit scores. In a typical advertising campaign, the advertising manager 234 may transfer the credit scoring algorithm 228 and weights 230 to a telecommunications network 238. The telecommunications network 238 may calculate credit scores and may use those credit scores to identify subscribers that meet criteria for an advertising campaign. In many such systems, the telecommunications network 238 may contact those subscribers on behalf of the bank with an advertisement.

The telecommunications network 238 may have a database of raw network data 240. The raw network data may be observations, logs, or other information that may come from managing or monitoring a telecommunications network. A statistics generator 242 may generate summary statistics that may be stored outside a firewall 244 as a database of mathematically descriptive statistics 246.

The mathematical statistics generator 242 may process raw telecommunications data to create mathematical representations of the data which may reflect behavioral differences between subscribers. The behavioral differences may be reflected in various statistics, allowing for various applications to identify subscribers that behave in similar or dissimilar fashions.

The raw data may include call data record data, which may include a timestamp, an event designator such as voice call, data transmission, or SMS communication, a sender identifier, a sender telephone number, a receiver identifier, a receiver telephone number, a call duration, data upload volume, and data download volume. An internet communication record may include a timestamp, a subscriber identifier, a subscriber telephone number, and a domain name. The domain name may be extracted from a Uniform Resource Identifier (URI) that may be retrieved from the Internet in response to an application or browser access of Internet data.

A location record may include a timestamp, a subscriber identifier, and latitude and longitude. Some telecommunications data may include customer relationship management records, which may include a month, a subscriber identifier, an activation date, a prepaid or postpaid plan identifier, a late payment indicator, an average revenue per unit, and a prepaid top-up amount.

The raw telecommunications data may be aggregated for each subscriber, then statistics may be generated from the aggregated data. In many cases, a large number of statistics may be used by various unsupervised learning mechanisms, then the unsupervised learning systems may determine which statistics may have the highest influence. Such systems may benefit from very large numbers of statistics from which to select meaningful statistics, and in many cases, some use cases may identify one set of statistics that may be significant, while another use case may find that a different set of statistics may be significant. Such systems may benefit from a large set of different statistics.

In some systems, raw telecommunications data may be obfuscated prior to analysis. Obfuscation may limit the precision, accuracy, or reliability of the raw data, but may retain sufficient statistical significance from which similarities and other analyses may be made. One mechanism for obfuscating data may be to decrease the precision of the data. For example, many raw telecommunications data entries may include a timestamp, which may be provided in year, month, day, hours, minutes, and seconds. One mechanism to obfuscate the data may be to remove the seconds or even minutes data from the timestamps, or to put the time stamps into buckets, such as buckets for every 15 or 20 minutes within an hour. Such a reduction in granularity may preserve some meaning of many of the statistics while obscuring the underlying data.

Another application of data obfuscation may be to limit the precision of location information. For example, some location information may have a high degree of precision, such as Global Positioning System (GPS) satellite location data. A method of obfuscation may be to limit the latitude and longitude to only one or two digits past the decimal point for such data points. Such an obfuscation may limit the location precision to approximately 1km or 100m, respectively.

Another obfuscation method may be applied to web browsing history, which may be obfuscated by limiting any Uniform Resource Identifier (URI) data entries to the top level domain only. Many URI records may include several parameters that may identify specific web pages or may embed data into a URI. By removing such excess information, web page or application access to the Internet may be obfuscated.

Statistics that may be generated from the telecommunications data may include first, second, and third order statistics such as count, sum, maximum, minimum, mean, frequency, ratio, fraction, standard deviation, variance, and other statistics. Such statistics may be generated from any of the various

Higher order statistics may include entropy. Entropy may be the negative logarithm of the probability mass function for a value, and may represent the disorder or uncertainty of the data set. Entropy may further be analyzed over time, where changes in entropy may identify behavioral changes by a subscriber. For example, in telecommunications data, a cell tower log may identify that a subscriber's device was in the vicinity of the cell tower. In this case, the cell tower locations may be a proxy for a subscriber's location, and the entropy of the subscriber's interactions with the location may reflect the subscriber's movement behavior.

Other higher order statistics may include periodicity, regularity, and inter-event time analyses. Periodicity analysis may identify a subscriber's regular behaviors, which may be caused by sleep patterns, job attendance, recreation, and other activities. Even though the specific activities of the subscriber may not be directly identified by the telecommunications data, the effects of those behaviors may be present in the mathematically descriptive statistics. Periodicity may be identified through Fourier transformation analysis or auto-correlation of time series of the subscriber's behaviors. Such analyses may be performed against location-related information, but also other data sets, such as texting, calling, and web browsing activities. Regularity may be statistics related to the consistency of the behaviors, while the inter-event time analyses may generate statistics relating to the time between events or sequence of events.

Some statistics may be generated from interactions between subscribers. Many subscribers may have a small number of other people with whom the subscriber may communicate frequently. Such people may be family members, friends, coworkers, or other close associates. The interactions may be consolidated into a graph of subscribers. In some cases, a pseudo social network graph may be created by identifying subscribers with common attributes, such as subscribers who may visit a specific cell tower location. From such graphs, several types of centrality and other attributes may be calculated. Centrality may be in the form of degree centrality, closeness centrality, betweenness centrality, eigenvector centrality, information centrality, and other statistics. Other attributes may include nodal efficiency, global and local transitivity, relationship strengths, and other attributes.

The statistics may be categorized by communication features, location features, online features, and social network features. Each feature may be a statistic calculated from the raw telecommunications data and may be inherently unobservable from outside the telecommunications network. Further, such features may be a first order or higher statistic that may not correlate with or contain semantic information about a subscriber.

TABLE 2
List of Communication Features

| | | | Derived | |
|---|---|---|---|---|
| Statistic | Type | Units | from | Direction |
| Count of communications | Integer | Communi- | Call, | In, Out, |
| | | cations | SMS, | Both |
| | | | both | |
| Proportion of SMS to call | Percentage | Unitless | Both | In, Out, |
| + | | | | Both |
| SMS | | | | |
| Proportion of | Percentage | Unitless | Call, | Both |
| outgoing to | | | SMS, | |
| incoming + outgoing | | | Both | |
| commu- nications | | | | |
| Sum of call dura- | Integer | Seconds | Call | In, Out, |
| tion | | | | Both |
| Mean call dura- | Decimal | Seconds | Call | In, Out, |
| tion | | | | Both |
| S.D. of call dura- | Decimal | Seconds | Call | In, Out, |
| tion | | | | Both |
| Mean interevent time | Decimal | Seconds | Call, | In, Out, |
| | | | SMS, | Both |
| | | | Both | |
| S.D. of interevent time | Decimal | Seconds | Call, | In, Out, |
| | | | SMS, | Both |
| | | | Both | |
| Count of re- sponses | Integer | Communic | Call, | Out |
| | | | SMS, | |
| | | | Both | |
| Fraction of com- | Ratio | Unitless | Call, | Out |
| munications | | | SMS, | |
| responded | | | Both | |
| Mean response time | Decimal | Seconds | Call, | In, Out, |
| | | | SMS, | Both |
| | | | Both | |
| S.D. of response time | Decimal | Seconds | Call, | In, Out, |
| | | | SMS, | Both |
| | | | Both | |
| Communications regularity | Decimal | | Call, | In, Out, |
| | | | SMS, | Both |
| | | | Both | |
| Autoregression coefficient | Decimal | | Call, | In, Out, |
| | | | SMS, | Both |
| | | | Both | |

TABLE 3
List of Location Features

| Feature | Type | Unit | Time Dimension |
|---|---|---|---|
| Count of total locations | [symbol] | [symbol] | [symbol] |
| interacted with | | | |
| Count of distinct locations | [symbol] | [symbol] | [symbol] |
| interacted with | | | |
| Count of hand-off s (if | [symbol] | [symbol] | [symbol] |
| there is any) | | | |
| top 5 locations interacted | [symbol] | [symbol] | [symbol] |
| with | | | |
| total distance traveled | [symbol] | [symbol] | [symbol] |
| Mean (over days) radius of | Decimal | Kilometres | W × (T ∪ D) |
| gyration | | | |
| Sum of distance travelled | Decimal | Kilometres | W × (T ∪ D) |
| Count of locations visited | Integer | Locations | W × (T ∪ D) |
| Location entropy | Decimal | Unitless | W × (T ∪ D) |
| Count of frequent loca- | Integer | Locations | Month |
| tions | | | |
| Frequent location entropy | Decimal | Unitless | Month |
| Mean regularity of fre- | Integer | Unitless | Month |
| quent locations | | | |
| Mean distance from call | Decimal | Kilometres | W × (T ∪ D) |
| counterparty | | | |
| Mean distance from SMS | Decimal | Kilometres | W × (T ∪ D) |
| counterparty | | | |
| Mean distance from | Decimal | Kilometres | W × (T ∪ D) |
| call + SMS counterparty | | | |
| S.D. of distance from call | Decimal | Kilometres | W × (T ∪ D) |
| counterparty | | | |
| S.D. of distance from SMS | Decimal | Kilometres | W × (T ∪ D) |
| counterparty | | | |
| S.D. of distance from | Decimal | Kilometres | W × (T ∪ D) |
| call + SMS counterparty | | | |

[symbol]

indicates data missing or illegible when filed

TABLE 4
List of Web Usage Statistics

| Feature | Type | Unit | Time Dimension |
|---|---|---|---|
| Count of total web visit | [symbol] | [symbol] | [symbol] |
| Count of distinct domains | Integer | [symbol] | [symbol] |
| visited | | | |
| Count of total app use | Integer | [symbol] | [symbol] |
| Count of distinct app used | Integer | [symbol] | [symbol] |
| top 5 web sites | list | [symbol] | [symbol] |
| top 5 app used | Integer | [symbol] | [symbol] |
| Diversity of domain | [symbol] | [symbol] | [symbol] |
| Diversity of app use | [symbol] | [symbol] | [symbol] |

[symbol]

indicates data missing or illegible when filed

TABLE 5
List of Social Network Features

| Dimension | Type | Unit | Mode | Direction |
|---|---|---|---|---|
| Degree centrality | [symbol] | [symbol] | Call, SMS, | In, Out, |
| | | | Both | Both |
| Closeness centrality | [symbol] | [symbol] | Call, SMS, | Both |
| | | | Both | |
| Betweenness cen- | [symbol] | [symbol] | Call, SMS, | Both |
| trality | | | Both | |
| Eigenvector cen- | [symbol] | [symbol] | Call, SMS, | Both |
| trality | | | Both | |
| Information cen- | [symbol] | [symbol] | Call, SMS, | Both |
| trality | | | Both | |
| Nodal efficiency | [symbol] | [symbol] | Call, SMS, | Both |
| | | | Both | |
| Mean nodal effi- | [symbol] | [symbol] | Call, SMS, | Both |
| ciency | | | Both | |
| Local efficiency | [symbol] | [symbol] | Call, SMS, | Both |
| | | | Both | |
| Mean local effi- | [symbol] | [symbol] | Call, SMS, | Both |
| ciency | | | Both | |
| Global transitivity | [symbol] | [symbol] | Call, SMS, | Both |
| | | | Both | |
| Local transitivity | [symbol] | [symbol] | Call, SMS, | Both |
| | | | Both | |
| Mean local transi- | [symbol] | [symbol] | Call, SMS, | Both |
| tivity | | | Both | |
| Davis & Lein- | [symbol] | [symbol] | Call, SMS, | Both |
| hardt's triads (1, 3, | | | Both | |
| 11, 16) | | | | |
| Kalish & Robins' | [symbol] | [symbol] | Call, SMS, | Both |
| triads {WWW, SSS, | | | Both | |
| WNW, WSW, SNS, | | | | |
| SNW, SWS, SWW, | | | | |
| SSW} | | | | |
| Mean communica- | [symbol] | [symbol] | Call, SMS, | In, Out, |
| tions per contact | | | Both | Both |
| Contacts entropy | [symbol] | [symbol] | Call, SMS, | In, Out, |
| | | | Both | Both |
| Subgraphdensity of | [symbol] | [symbol] | Call, SMS, | Both |
| neighbors | | | Both | |
| Count of strong | [symbol] | [symbol] | Call, SMS, | Both |
| contacts | | | Both | |
| Mean credit score of | [symbol] | [symbol] | | |
| neighbours | | | | |

[symbol]

indicates data missing or illegible when filed

The mathematical statistics generator 242 may create hashed or otherwise anonymized versions of subscriber's identification. Such information may be placed in an identification key database 252 for later correlation in some use cases. In many cases, the mathematically descriptive statistics generated by the mathematical statistics generator 242 may be produced with hashed identifiers such that analyses may not return identifiers that may compromise a subscriber's privacy.

In many cases, the mathematically descriptive statistics 246 may be stored with anonymized user identifiers. Such a configuration may allow for many different uses of the data without sacrificing user identities. For example, marketing analyses may be performed to determine the number of subscribers who visit certain attractions, who travel using public transportation, or a myriad of other uses. A query manager 248 may receive requests for such data, perform a query against the database of mathematically descriptive statistics 246, and may return the results.

In some cases, identifiers for specific subscribers may be presented to obtain those subscriber's statistics. Since the database of mathematically descriptive statistics 246 may include only anonymized identifiers, an identification query engine 250 may perform a query of a set of identification keys 252 to determine the anonymized identifier for a specific user. The anonymized identifier may then be used to query the mathematically descriptive statistics 246 and return that subscriber's data.

A privacy certifier service 252 may provide third party verification of privacy-related issues for communications between the banking device 202 and the telecommunications network 238. The third party privacy certifier service 252 may analyze transmission to verify various levels of privacy. For example, one type of analysis may verify that no data is being transmitted that can be used to identify individuals. Another analysis may verify that when private information may be transferred, the transmitting and receiving entities may have valid permission for such transmissions. As one such example, a bank may obtain permission from a prospective customer to obtain data to calculate a credit score. Such permission may be incorporated in the transmission or otherwise made available to the privacy certifier service 252.

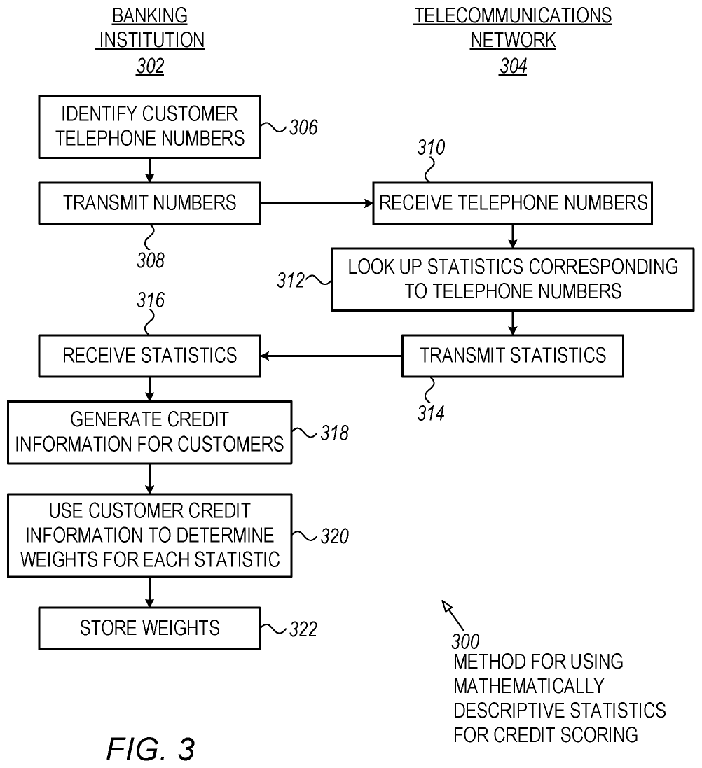

FIG. 3 is a flowchart illustration of an embodiment 300 showing a method for using mathematically descriptive statistics for credit scoring. The operations of a banking institution 302 may be shown in the left hand column, while operations of a telecommunications network 304 may be shown in the right hand column.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principals of operations in a simplified form.

Embodiment 300 illustrates a method where telecommunications network data may be used with a bank's financial information to generate credit scores. The information from each source may be kept within each organization such that neither organization may be exposed to the other organization's sensitive information. The telecommunications network 304 may generate summary statistics which may include useful behavioral data about subscribers, but may not include network-specific data that may be considered proprietary. Similarly, a bank 302 may use internal financial data to determine creditworthiness information, but such information may not be shared with the telecommunications network 304.

A banking institution 302 may identify a list of customer's telephone numbers in block 306. The telephone numbers may be transmitted in block 308 to the telecommunications network 304, which may receive the numbers in block 310.

The telecommunications network 304 may look up statistics for those telephone numbers in block 312 and transmit the statistics in block 314, which may be received in block 316 by the banking institution 302.

The banking institution 302 may generate credit information for the customers in block 318 and use the credit information and the statistics to generate a set of weights. The set of weights may be generated by linear regression or some other mechanism. The weights may be stored in block 322 for later use to calculate credit scores.

The communications between the banking institution 302 and the telecommunications network 304 may be constructed to minimize or remove exposure of sensitive information about the customers. When sensitive information may be transmitted, encryption or other privacy mechanism may be used.

For example, the transmission of telephone numbers in block 308 may be considered private information, as the numbers may be actual telephone numbers of customers. In some cases, the transmission may be encrypted or otherwise protected.

In the transmission of statistics in block 314, the private information may be the association of specific telephone numbers to a subscriber's behavior statistics. Some systems may transmit only the statistics without the associated telephone numbers. By preserving the order of the statistics to correlate with the original order of the telephone numbers transmitted in block 308, the banking institution 302 may be able to correlate the statistics to specific telephone numbers, however, the transmission of statistics in block 314 may be considered anonymized.

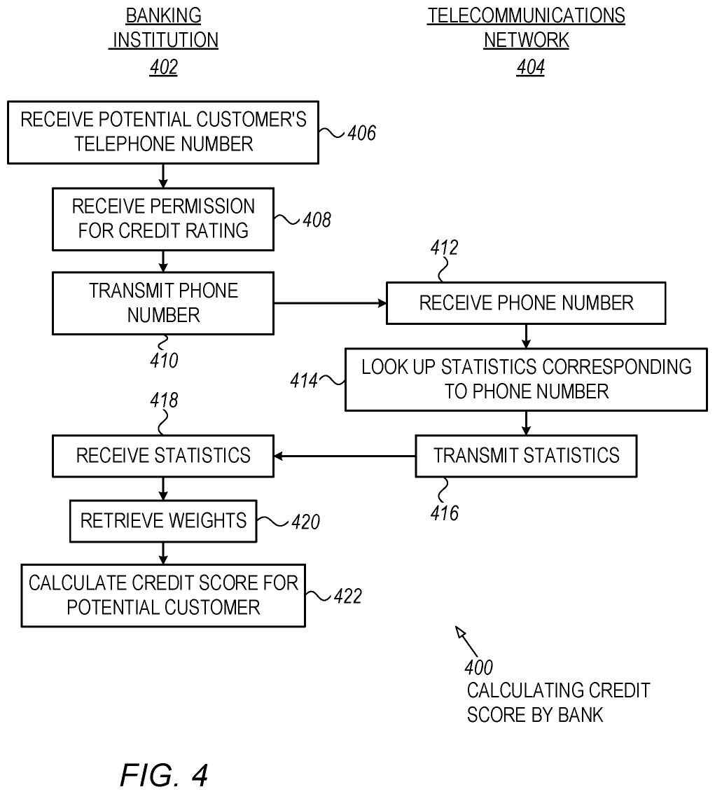

FIG. 4 is a flowchart illustration of an embodiment 400 showing a method for calculating a credit score by a bank. The operations of a banking institution 302 may be shown in the left hand column, while operations of a telecommunications network 304 may be shown in the right hand column.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principals of operations in a simplified form.

Embodiment 400 may illustrate a use of a credit scoring algorithm that uses telecommunications network statistics to estimate a potential client's credit score. The basis of the credit score may be the similarities of behavior between customers with a known credit score and the behavior of a potential customer.

A potential customer's telephone number may be received in block 406 along with permission to obtain a credit score in block 408. The phone number may be transmitted in block 410 to the telecommunications network 404, which may receive the number in block 412. The telecommunications network 404 may look up the statistics associated with the phone number in block 414, and transmit the statistics in block 416.

The statistics may be received in block 418 by the banking institution 402, which may retrieve the weights used by the credit scoring algorithm in block 420 and may calculate the credit score in block 422.

The operations of embodiment 400 may be a use case where the banking institution 402 may not expose the telecommunications network 404 to any sensitive banking or financial information. Similarly, the telecommunications network 404 may supply mathematically descriptive statistics which may be summarized statistics from telecommunications operations. In this case, the telecommunications network 404 may supply statistics for a specific user, which may be supplied only when the subscriber has given consent for their data to be shared.

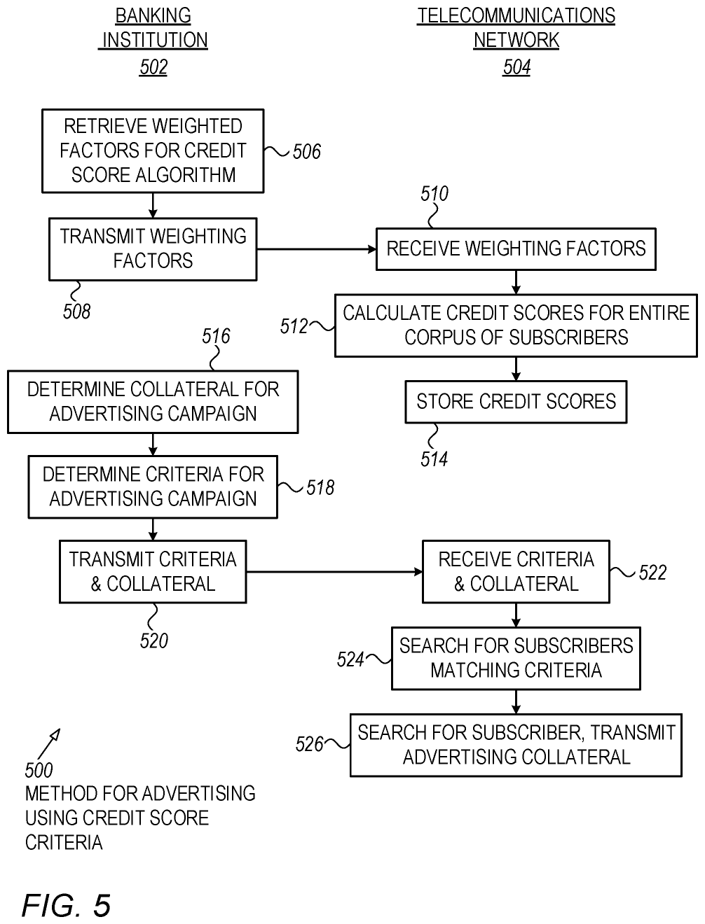

FIG. 5 is a flowchart illustration of an embodiment 500 showing a method for calculating a credit score for large numbers of subscribers of a telecommunications network. The operations of a banking institution 502 may be shown in the left hand column, while operations of a telecommunications network 504 may be shown in the right hand column.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principals of operations in a simplified form.

Embodiment 500 may illustrate a use case where weighting factors for a credit score algorithm may be calculated by a banking institution 502 and supplied to a telecommunications network 504. This transfer may allow a telecommunications network 504 to calculate credit scores for subscribers where the banking institution may not have permission to access those credit scores. However, the telecommunication network 504 may have permission to generate statistics, and the credit score may be considered one of such statistics.

The banking institution 502 may generate the weighting factors based on the banking institution's internal data about the creditworthiness of their customers. The creditworthiness of the customers may be sensitive and private information, yet the weights used may be considered proprietary information of the bank. In many such cases, the telecommunications network 504 may generate credit scores but only use those credit scores when the banking institution 502 makes requests such as in the example of embodiment 500.

In the example of embodiment 500, the banking institution 502 may send information to the telecommunications network 504 to execute an advertising campaign. The banking institution 502 may not have permission to contact the telecommunications network subscriber's directly, however, the telecommunications network 504 may have permission. In this example, the telecommunications network 504 may contact its subscribers on behalf of the banking institution 502.

The banking institution 502 may retrieve weighting factors for the credit score algorithm in block 506 and transmit those factors in block 508 to the telecommunications network 504, which may receive the factors in block 510. The telecommunications network 504 may calculate credit scores for all its subscribers in block 512 and store those credit scores in block 514.

The banking institution 502 may determine collateral for an advertising campaign in block 516 as well as criteria for the campaign in block 518. The collateral may be advertising materials or messages that may be used in a campaign, and the criteria may be those factors identifying potential customers that the campaign may be intended to reach. One of the criteria may be a credit score range that may be appropriate for the campaign.

The banking institution 502 may transmit the collateral and criteria in block 520, which may be received by the telecommunications network 504 in block 522. The telecommunications network 504 may search for subscribers matching the criteria in block 524 and may transmit the advertising collateral to those subscribers in block 526.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principals of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

1. A system comprising:
at least one computer processor;
said at least one computer processor configured to perform a method comprising:
receiving a first list of phone identifiers;
for each of said phone identifiers in said first list, obtaining a first vector of calculated statistics being derived from telecommunications network observations;
obtaining a second vector of weighting factors;
for each of said phone identifiers, determining a calculated credit score by taking a dot product of said first vector and said second vector;
for each of said phone identifiers, determining an observed credit score by analyzing financial behavior;
for each of said weighting factors, computing an updated weighting factor by comparing said calculated credit scores and said observed credit scores for each of said phone identifiers; and
storing said updated weighting factors in an updated vector of weighting factors.

2. The system of claim 1, said method further comprising:
receiving a third vector comprising calculated statistics associated with a first phone identifier, said first phone identifier not having said financial behavior;
calculating a first credit score associated with said first phone identifier by taking a dot product of said third vector and said updated vector of weighting factors.

3. The system of claim 2,
said first vector of calculated statistics being obtained from a second system;
said method further comprising:
transmitting said updated vector of weighting factors to said second system.

4. The system of claim 3, said method further comprising:
sending a request for customers having a predefined range of credit scores to said second system; and
receiving a set of identifiers associated with individuals having said predefined range of credit scores.

5. The system of claim 3, said method further comprising:
sending a request for customers having a predefined range of credit scores to said second system, said second system obtaining a set of customers having said predefined range of credit scores and transmitting said set of customers to a third system, said third system being configured to contact a subset of said set of customers.

6. The system of claim 5, said third system having obtained consent from said subset of said set of customers.

7. The system of claim 1, said computing said updated weighting factors being performed at least in part by regression.

8. The system of claim 1, said first vector of calculated statistics comprising movement observation statistics.

9. The system of claim 8, said movement observation statistics comprising a radius of gyration.

10. The system of claim 8, said first vector of calculated statistics comprising telephone communication behavior.

11. The system of claim 10, said first vector of calculated statistics comprising mobile device data consumption behavior.

12. A method performed by at least one computer processor, said method comprising:
receiving a first list of phone identifiers;
for each of said phone identifiers in said first list, obtaining a first vector of calculated statistics being derived from telecommunications network observations;
obtaining a second vector of weighting factors;
for each of said phone identifiers, determining a calculated credit score by taking a dot product of said first vector and said second vector;
for each of said phone identifiers, determining an observed credit score by analyzing financial behavior;
for each of said weighting factors, computing an updated weighting factor by comparing said calculated credit scores and said observed credit scores for each of said phone identifiers; and
storing said updated weighting factors in an updated vector of weighting factors.

13. The method of claim 12 further comprising:
receiving a third vector comprising calculated statistics associated with a first phone identifier, said first phone identifier not having said financial behavior;
calculating a first credit score associated with said first phone identifier by taking a dot product of said third vector and said updated vector of weighting factors.

14. The method of claim 13,
said first vector of calculated statistics being obtained from a second system;
said method further comprising:
transmitting said updated vector of weighting factors to said second system.

15. The method of claim 14 further comprising:
sending a request for customers having a predefined range of credit scores to said second system; and
receiving a set of identifiers associated with individuals having said predefined range of credit scores.

16. The method of claim 14 further comprising:
sending a request for customers having a predefined range of credit scores to said second system, said second system obtaining a set of customers having said predefined range of credit scores and transmitting said set of customers to a third system, said third system being configured to contact a subset of said set of customers.

17. The method of claim 16, said third system having obtained consent from said subset of said set of customers.

18. The method of claim 12, said computing said updated weighting factors being performed at least in part by regression.

19. The method of claim 12, said first vector of calculated statistics comprising movement observation statistics.

20. The method of claim 19, said movement observation statistics comprising a radius of gyration.
